(19) United States
(12) Patent Application Publication
(10) Pub. No.: US 2007/0273225 A1
(43) Pub. Date: Nov. 29, 2007

(54) Electric Motors for Powering Downhole Tools

(76) Inventor: Philip Head, West Drayton (GB)

Correspondence Address: K.F. ROSS P.C., 5683 RIVERDALE AVENUE, SUITE 203 BOX 900, BRONX, NY, 10471-0900, US

(21) Appl. No.: 10/580,303

(22) PCT Filed: Nov. 19, 2004
(86) PCT No.: PCT/EP04/53029

§ 371 Date: Jan. 29, 2007

(30) Foreign Application Priority Data
Nov. 20, 2003 (GB) 0327023.8

(51) Int. Cl. H02K 3/44; F04D 13/10; H02K 5/12

(52) U.S. Cl. 310/87; 310/152

(57) ABSTRACT

An electric motor, for powering downhole tools, comprises a stator and a rotor connectable to a rotatable device, a permanent magnet and a series of coiled windings or laminations having a connection to a DC supply, the permanent magnet and the laminations being arranged annularly with respect to each other, characterised in that the laminations and coil windings are potted in a potting material impervious to wellbore fluids. The potting material are introduced under a vacuum, and the motor housing confines the potting material, acting as a mould.

The present invention relates generally to downhole pumping systems and, more particularly to a new electric motor for use with a downhole tools such as a pumping system and which does not require a conventional protector.

Electric submersible pumps (ESPs) are widely used throughout the world for recovering subterranean fluids to the earth's surface. For the long term successful operation of such submersible pumping systems, the electric motor is supplied with uncontaminated motor oil. The motor oil not only lubricates the motor, it also cools the motor to prevent overheating. In most submersible pumping systems in use today, this motor oil is partially contained within a device commonly referred to as a motor protector. Conventional motor protectors typically include one or more elastomeric bags. These elastomeric bags provide two important functions: (1) equalising the fluid pressure within the motor to that in the adjacent wellbore and (2) preventing well fluids and gases from contaminating the motor oil. In regard to the first function, it should be understood that the temperature of the motor oil varies as a result of the intermittent operation of the submersible motor. As the temperature of the motor oil rises, for instance, the oil tends to expand and the pressure within the motor tends to increase. If the motor protector did not include an expandable member, such as the elastomeric motor protector bag, the internal pressure of the motor would increase dramatically. However, the motor protector bag expands and contracts to compensate for the varying liquid volume and to maintain a relatively constant pressure within the motor. In regard to the second function, the motor protector bag provides a degree of isolation between the motor oil and the well fluids and gases. This isolation helps keep the motor oil clean to increase the longevity of the motor. Most elastomeric motor protector bags prevent many contaminants, such as crude oil, water, brine, and dirt, which may greatly reduce the life of the motor, from entering the motor.

As discussed above, in many applications elastomeric motor protector bags perform reasonably well. However, elastomeric bags suffer from several limitations. First, the repeated expanding and contraction of the elastomeric bag can cause the bag to split or crack under certain conditions. Of course, once an elastomeric bag splits or cracks it no longer protects the motor oil from contaminants which are then free to enter and ultimately damage the motor. Second, elastomeric bags tend to lose their elasticity due to various conditions which may be present in a wellbore. Once an elastomeric bag loses its elasticity, it can no longer expand and contract as needed to satisfy the requirements of the motor oil which it contains. Eventually the bag will rupture, leaving the contaminants free to attack the motor. Third, most elastomers cannot survive in environments where the temperature rises above about 400 Deg F. (around 200° C.). Above that temperature, most elastomers become brittle causing the bag to break during expansion or contraction. Finally, elastomeric compounds currently used for motor protector bags tend to be relatively permeable as compared to the contaminants within the wellbore fluid. Many wells contain contaminants, such as hydrogen sulphide for instance, which will permeate the motor protector bag and attack the motor. In fact, certain contaminants, such as hydrogen sulphide, also tend to alter the chemistry of certain elastomers, causing the elastomers to harden. Once the elastomer has hardened, the bag eventually breaks. In an effort to combat one or more these problems, the elastomeric material used to fabricate the motor protector bags have been studied and chosen to provide certain advantages. For instance, certain elastomers may slow the rate at which contaminants such as hydrogen sulphide enter the motor, but they cannot stop the permeation completely. Alternatively, certain elastomers may exhibit an ability to withstand temperatures as high as about 400 Deg F. (200° C.), but these elastomers tend to have limited elasticity incompatible with the requirements of the motor.

Coil windings in a motor are typically insulated copper wire. Besides providing additional protection, the insulation on the copper wire is provided to prevent arcing over to other components of the motor. One method commonly used in insulating the copper wire involves coating the copper wire with an impervious material, usually enamel or varnish. Generally, the coating process is good but not perfect enough to prevent small holes, called “pin-holes”, in the enamel or varnish. When the copper wire is wound into a coil, the probability of one pin-hole lying next to another pin-hole is low, and the layer of enamel or varnish between the coil prevents conduction from one pin-hole to the next.

When the electric motor is employed in a wellbore, the electric motor operates in the presence of wellbore fluids, which typically contain electrically conductive fluids, e.g., salt water. If an electrically conductive fluid gets in between the coil, conduction from one pin-hole to the next will occur, leaving the motor vulnerable to immediate short-circuit failure.

The object of the invention is to provide a new electric motor arrangement for powering downhole tools which avoids these problems with the use of protector bags for protecting motors from the downhole environment.

According to the present invention, there is provided an electric motor, for powering downhole tools, comprising a stator and a rotor connectable to a rotatable device, a permanent magnet and a series of coiled windings or laminations having a connection to a DC supply, the permanent magnet and the laminations being arranged annularly with respect to each other, characterised in that the laminations and coil windings are potted in a potting material impervious to wellbore fluids.

According to another aspect of the present invention, there is provided an electric motor assembly according to claim 6, wherein the motor electric motors are secured together before the potting material is introduced.

According to another aspect of this invention the lamination modules can have moulded in electrical contacts which can resist the very high pressures experienced in oil wells.

According to another aspect of this invention, the motor housing may act as the potting mould.

According to another aspect of the invention the motor wiring may be exited from the potted material through a metal clad tube, onto which an O ring seal can be used.

According to another aspect of this invention, small solid shaft motors are used to actuate sensors and other logging type tools.

Several embodiments of the invention will now be described with reference to the following drawings in which:

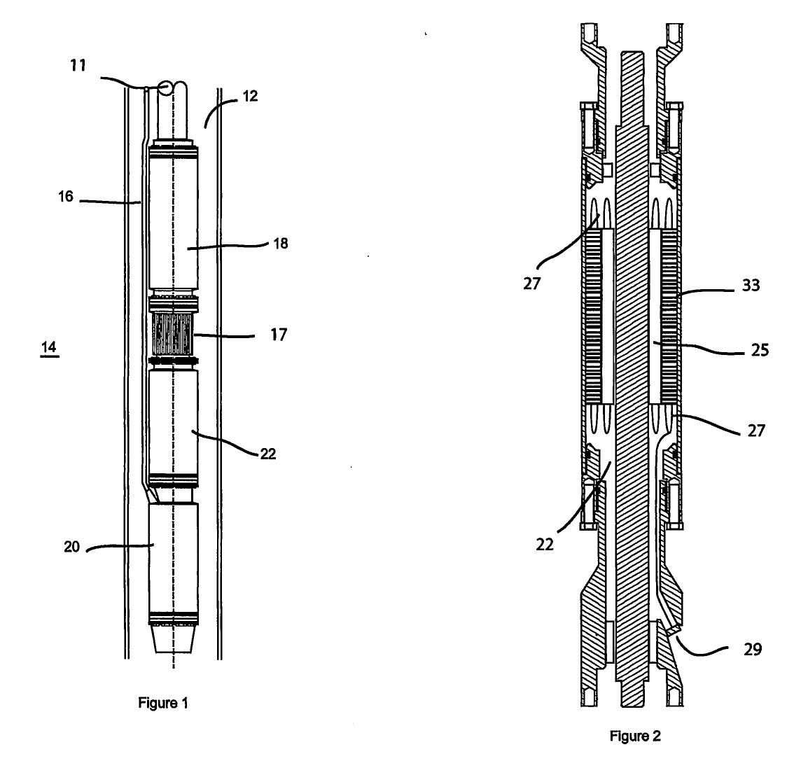

FIG. 1 is a view of the general arrangement of an existing downhole motor used to power a pump;

FIG. 2 is a longitudinal cross section of a typical prior art motor used in FIG. 1;

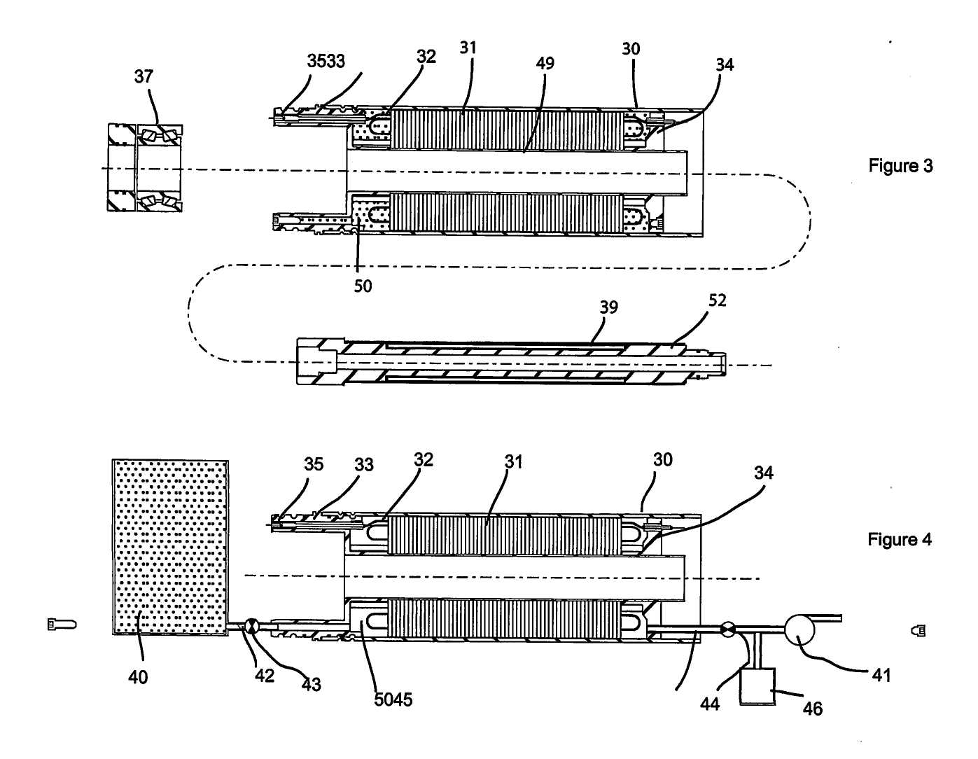

FIG. 3 shows a cross section of view of a motor assembly in several parts;

FIG. 4 shows the same motor assembly in FIG. 3, in an earlier stage of manufacture;

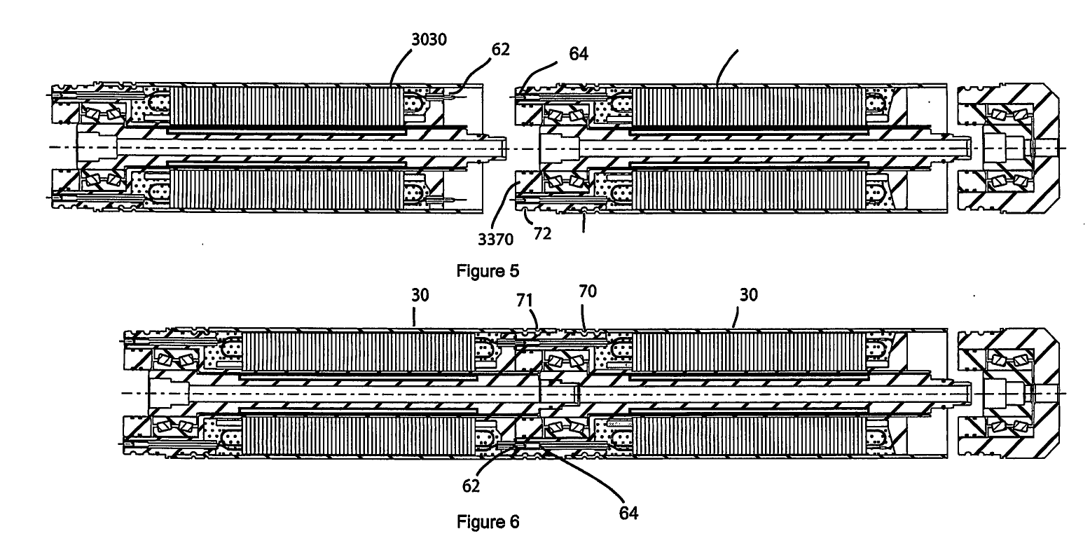

FIG. 5 shows two motors as shown in FIG. 3 assembled and about to be joined together;

FIG. 6 shows the two motors in FIG. 5 assembled;

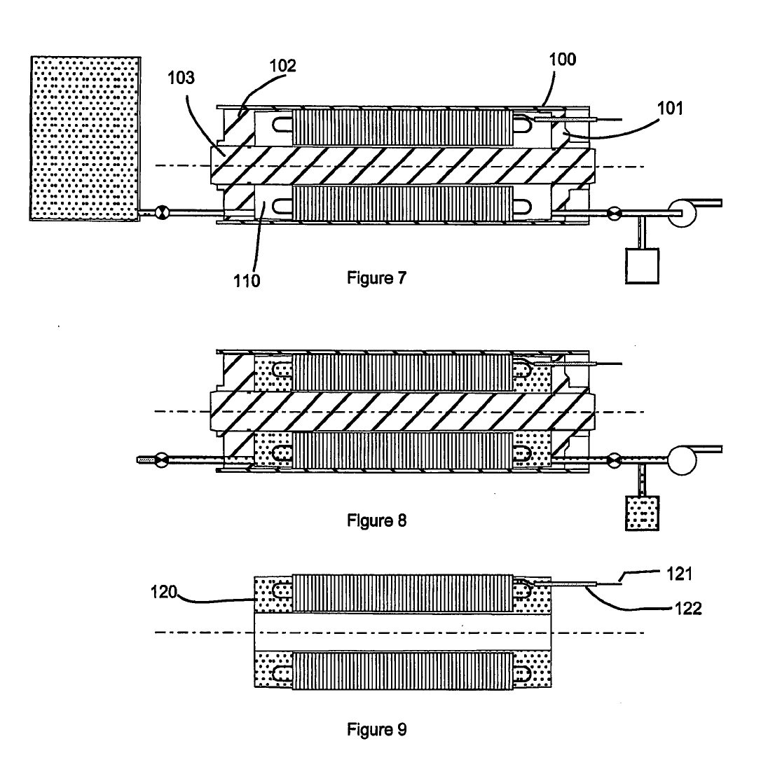

FIG. 7 shows a second motor assembly prior to being potted;

FIG. 8 shows the motor assembly in FIG. 7 being potted;

FIG. 9 shows the motor assembly in FIG. 8 with the mould tooling removed;

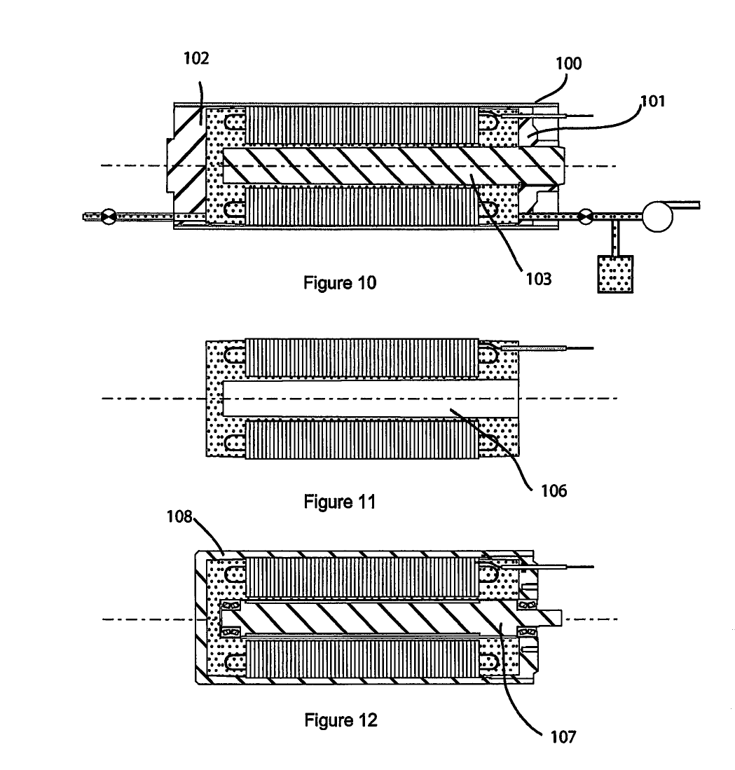

FIG. 10 shows a further motor assembly being potted;

FIG. 11 shows the potted motor assembly in FIG. 10 with the mould tooling removed;

FIG. 12 shows the motor assembly in FIG. 11 having been fitted with cladding.

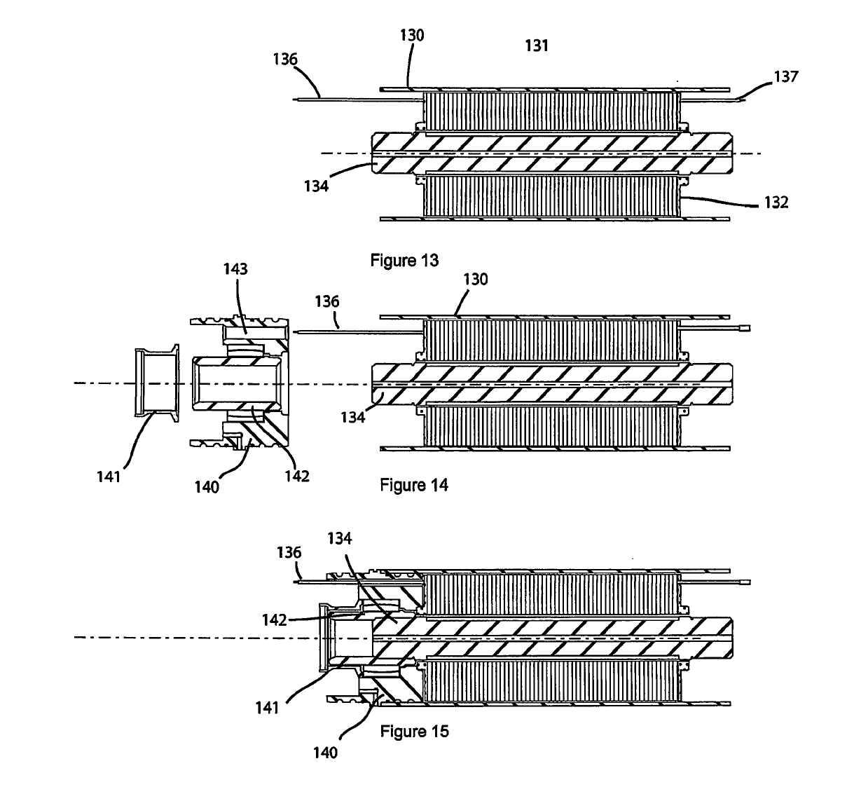

FIGS. 13 to 18 shows the fabrication and potting of another embodiment of the motor assembly.

Where equivalent components appear in different embodiments, the same designating numeral will be used.

Referring initially to FIG. 1, a pumping system shown located in a well bore 12 that has been created within a subterranean formation 14. Although not specifically illustrated, it is well known that the well bore 12 contains fluids and gases from the surrounding formation 14 and that the pumping system is adapted to be submerged in these fluids and gases within the well bore 12. The pumping system is typically part of a production tubing string 16 and is responsible for pumping fluids and/or gases from the well bore 12 to the surface of the Earth. The pumping system includes a pump 18 that is driven by a motor 20. The motor 20 is advantageously an electric motor. The motor 20 contains motor oil (not shown) which lubricates and cools the motor 20. A motor protector 22 is coupled to the motor 20. The motor protector 22 contains a portion of the motor oil, and it functions to keep the motor oil free from contaminants and to maintain a relatively constant pressure within the motor 20. Although the motor protector 22 is illustrated in this example as being coupled between the pump 18 and the motor 20, it should be understood that other arrangements may be suitable.

FIG. 2 shows a longitudinal section through a conventional ESP motor. These are induction motors which are essentially rotary transformers in which power transfers to the secondary coil, on the rotor, which results in a rotation of a mechanical load. The tolerance between the rotating and non rotating components needs to be quite close. The magnetic field is set up in the stator's main inductance (the magnetising inductance), which typically comprises three windings 25 having a laminated soft iron core 33. Most of the input power couples to the rotor secondary winding and thus the load. The rotor winding also typically comprises three windings 27. The three stator windings are driven by utility power in phases separated by 120 degrees. The power is fed to the stator windings via a pot head 29. The result is a magnetic field that rotates around the motor axis at power frequency divided by the number of poles. Because there are windings on both rotating and non rotating components and the close tolerance between the rotor and stator, they have always had a common pressure compensated oil bath 22.

In FIGS. 3 to 6 there is shown a motor assembly in which the motor body housing forms the mould housing when the assembly is potted. FIG. 3 shows the motor assembly after the potting compound has been applied. A metal housing body 30 contains the motor laminations 31 and motor windings 32. At each end of the housing are end caps 33 and 34 through which are fed the motor wires 35 and any other sensor wires (not shown). The electrical wires are with electrical plugs and sockets capable of withstanding the differential pressures typically found at reservoir depths. A bore, defined by an impermeable tube 49, runs through the laminations 31 and motor windings 32. A rotor shaft 52 is introduced into the bore, and a bearing 37 is attached to the end of the assembly for the rotor to run on.

The motor is ideally a brushless DC motor, the rotor including permanent magnets 39, and the impermeable tube formed of non-magnetic stainless steel or a non-magnetic composite material tube, although it win be seen that the following principles could also be applied to other arrangements of motors.

When all the components are correctly placed inside the housing, a reservoir of potting material 40 is connected via a tube 42 and valve 43, a vacuum pump 41 is connected at the opposite end of the assembly via suitable piping 45, valve 44 and viewing bottle 46. The vacuum pump evacuates all the air and the potting material is allowed to flow into the housing the entire void area 50, completely filling the spaces around the winding wire with potting material. When cured the potting compound protects the laminations and windings from all the harmful wellbore fluids, provides an excellent heat transfer mechanism to the motor housing and provides excellent mechanical protection to the motor windings from fatigue failure.

A plurality of motor modules as shown in FIG. 5 can be plugged together electrically as shown in FIG. 6 where a male plug 62 mates with female sockets 64 to provide an electric path along a series of motor assemblies. The rotor shaft of neighbouring motor assemblies are also locked together e.g. by internal swaging.

Still referring to FIGS. 5 and 6, the end cap is secured to the metal housing by forming dimples 70 in the wall of the housing 30 to engage with pre-formed dimples in the end cap 33. The separate motor assemblies are then secured together by inserting the end cap 33 of one assembly into the housing 30 of the neighbouring assembly, and again deforming the housing to form dimples which engage with the end cap's pre-existing dimples. A suitable dimpling technique is shown in WO9741377, which eliminates the need to rotate either of the housings. Joining in this manner means that the adjacent motor housings are not turned relative to one another, and each rotor remains perfectly axially aligned with its lamination coils, which is particularly important with permanent magnet type motors.

Referring now to FIGS. 7 to 9 there is shown a second embodiment of this invention. In this embodiment a mould assembly 100, 101, 102 and 103 is used to position the lamination and windings prior to the injection of the potting material into the void spaces 110 contained within the mould. In this example, this motor would be used by itself and so only one set of motor windings would exit from the potting material, while the opposite end of the motor would have a completely flush end 120. The motor windings 121 would either be steel clad or exit through a small diameter metal tube 122. The metal tube would be potted into the assembly. Some tapers would have to be used on the moulded sections to ensure the tooling could be removed, however, this could be machined to parallel surfaces to the motor axis if required.

Referring to figure to FIG. 10, a lamination and windings are positioned in a mould assembly 100, 101, 102 and 103. It will be seen in this example that the mould piece 103 extends from one end only, so that the resultant bore 106, shown in FIG. 11, is blind. After the potted laminations and windings are removed from the mould, a rotor 107 is inserted into the bore 106, so that a portion of its shaft extends out of the bore. The potted laminations and windings are then clad in a protective sheath 108, preferably formed from metal, as shown in FIG. 12.

Referring to FIG. 13, in another embodiment of the invention a motor assembly section includes motor laminations 131 and motor windings 132 within a cylindrical metal housing body 130. A shaft section 134 extends through the windings. Electrical connection leads 136, 137 extend from both ends of the windings.

A connection member 140 and collar 141 are secured to one end of the motor assembly section, as shown in FIGS. 14 and 15. The connection member 140 abuts the inner surface of the metal housing body 130, the windings/laninations 131, 132. The connection member includes a rotatable ring 142 that is secured to the shaft, and transmits torque to the shaft. The collar 141 is non-rotatably secured to the connection member 140. The electrical connection lead 136 is threaded through a bore 143 in the connection member 140.

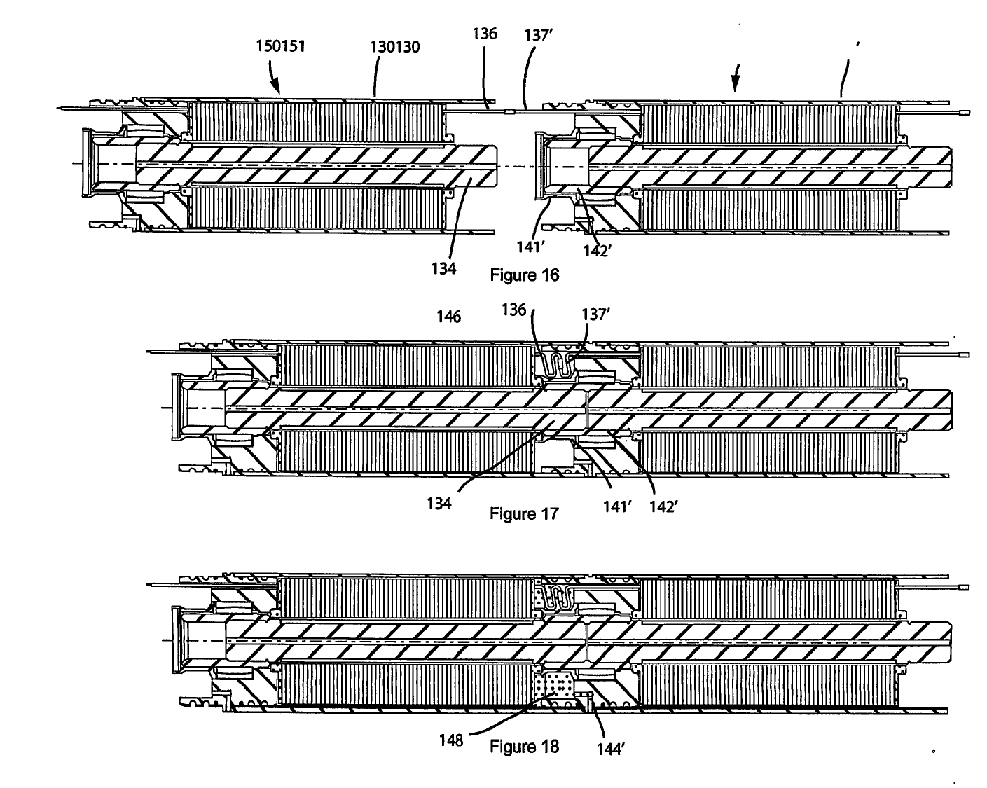

A series of such similar sections may be connected in series, as shown in FIGS. 16-18. Firstly, the opposite ends of two sections 150, 151 are brought into proximity, and the electrical connection lead 136 of 150 is connected to the corresponding lead 137′, as shown in FIG. 15. Referring to FIG. 16, the exposed end of the shaft 134 of section 150 is introduced to the collar 141′ of section 130′, where it engages abuts the shaft 134′ of the section 130′ and locks with rotatable ring 142, so that torque can be transmitted from shaft 134 to shaft 134′ via the collar 141′.

The connection member 140′ extends beneath both the metal housing 130 of the section 150, but also beneath the metal housing body 130′ of section 150′. The connection member 140′ features indentations on its surface. The neighbouring sections 150 and 151 can thus be secured using the dimpling methods previous described. The joined electrical connection leads 136 and 137′ become packed in an internal volume formed as the neighbouring sections are joined.

Referring to figure to FIG. 17, once the neighbouring sections 150 and 151 are secured together in this way, potting compound is injected into the internal volume of the joined sections via potting port 144′. The connecting leads, windings parts and other vulnerable elements of the motor assemblies can thus be protected from ingress of materials, pressure variations, movement/vibration etc.

Vent holes could be provided to encourage the movement of the potting compound into the whole of the internal volume. Alternatively, tie volume to be potted could extend all the way through each motor assembly section, so that potting ports of neighbouring sections allow air to exit the internal volume as the potting compound is introduced. Ideally, a vacuum is applied to these adjacent potting ports or to the vent holes to draw the potting compound into the internal volume and discourage the formation of air bubbles.

1. An electric motor, for powering downhole tools, the motor comprising:
a stators;
a rotor connectable to a rotatable devices;
a permanent magnets;
a series of coiled windings or laminations having a connection to a DC supply, the permanent magnet and the laminations being arranged annularly with respect to each other; and
a potting material impervious to wellbore fluids, the laminations and coil windings being potted in the material.

2. An electric motor according to claim 1, wherein the potting material is introduced under a vacuum.

3. An electric motor according to claim 1, further comprising
a motor housing which confines the potting material.

4. An electric motor according to claim 1, further comprising
wiring that exits from the potted material through a metal clad tube, onto which an O ring seal can be used.

5. An electric motor assembly comprising two or more electric motors according to claim 1 secured in series.

6. An electric motor assembly according to claim 5, wherein the two or more electric motors are secured together before the potting material is introduced.
